(19) United States
(12) Patent Application Publication
(10) Pub. No.: US 2025/0075529 A1
(43) Pub. Date: Mar. 6, 2025

(54) SQUARE SHAPED PUSH-BUTTON TYPE INDICATOR LOCK WITH EMERGENCY ESCAPE FUNCTION SUITABLE FOR DISABLED PEOPLE

(71) Applicant: Zhiyong LUO, Sichuan (CN)

(72) Inventor: Zhiyong LUO, Sichuan (CN)

(21) Appl. No.: 18/387,840

(22) Filed: Nov. 7, 2023

(30) Foreign Application Priority Data
Aug. 29, 2023 (CN) 2023224081081

(51) Int. Cl. E05B 13/00

(52) U.S. Cl. CPC E05B 13/002

(57) ABSTRACT

Square shaped push-button type indicator lock with emergency escape function suitable for disabled people, including a front handle and a front stop block installed on the front handle, a window is provided on the front stop block; a rear handle is provided opposite to the front handle; a rear stop block is installed on the rear handle; a rear fixing plate is installed inside the rear stop block, and front position limiting rods are installed inside the front stop block; the rear through member with a rear through rotary groove on its outer side is installed inside the rear handle; a pressure spring is provided inside the rear through member biasing a pressing member; a mounting through hole in which a guide pin is installed is formed on an upper peripheral portion of the pressing member; a push button is disposed at an outer end of the pressing member.

### BACKGROUND OF THE INVENTION

The present utility model relates to the technical field of indicator locks, in particular to a square shaped push-button type indicator lock with emergency escape function suitable for disabled people.

Locks refer to sealing devices configured on objects such as doors, cases, and drawers, which can only be opened with specified keys. Indicator locks refer to locks that have an indicating function. In order to improve the efficiency of use of locks, indicator locks are needed, but existing indicator locks still have the following defects:

Since rotation of a knob or handle is generally required to open most existing indicator locks, the existing indicator locks are inconvenient to be quickly operated by the disabled. Therefore, the existing indicator locks do not possess the versatility for operation during emergency situation, thereby causing reduced utility and reduced efficiency of the existing indicator locks.

In view of this, researches and improvements are made on the existing structures in view of the current defects of the indicator locks, and a square shaped push-button type indicator lock with emergency escape function suitable for disabled people is thus provided by the present utility model.

### BRIEF SUMMARY OF THE INVENTION

In view of the aforementioned defects in the prior art, it is an object of the present utility model to provide a square shaped push-button type indicator lock with emergency escape function suitable for disabled people.

To attain the above object, the present utility model provides the following technical solutions:

A square shaped push-button type indicator lock with emergency escape function suitable for disabled people, comprising a front handle and a rear through member; a front stop block is installed at a front end of the front handle; a rear handle is provided opposite to the front handle at a position opposite to a front end of the front stop block, and a rear stop block is installed at a front end of the rear handle facing towards the front stop block; a rear fixing plate is installed inside the rear stop block, and front position limiting rods are installed inside the front stop block; the rear through member is installed inside the rear handle proximal to the rear stop block, and a rear through rotary groove is formed outside the rear through member; a pressure spring is disposed inside the rear through member; a pressing member is installed at a front end of the pressure spring; a mounting through hole is formed on an upper peripheral portion of the pressing member, a guide pin is installed in the mounting through hole; a push button is disposed at an end of the pressing member opposite to an end of the pressing member installed with the pressure spring.

Further, an external diameter of the pressing member corresponds to an internal diameter of the rear through member so that an external surface of the pressing member is positioned closely adjacent to an internal surface of the rear through member.

Further, the pressing member is inserted into the rear through member, and the pressing member is biased by the pressure spring in the rear through member.

Further, an internal size of the rear through rotary groove corresponds to an external size of the guide pin, and the pressing member is rotatably connected with the rear through rotary groove through the guide pin.

Further, an internal diameter of the mounting through hole corresponds to an external diameter of the guide pin, and the guide pin is connected with the pressing member through the mounting through hole.

The present utility model provides a square shaped push-button type indicator lock with emergency escape function suitable for disabled people, which has the following beneficial effects:
1. According to the present utility model, the front stop block provided at the front end of the front handle has a square shape, instead of a circular assembled structure usually found in the existing indicator locks, to prevent problems of decreased structural firmness and poor stability in performance leading to reduced efficiency in the use of indicator locks. Specifically, the front handle is fixedly installed in a middle of the outer side of the front stop block; likewise, the rear stop block also has a square shape, and the rear handle is installed in a middle of the outer side of the rear stop block; the front stop block has the same dimensions as the rear stop block. Compared with a circular assembled blocking cover in the prior art, the present utility model provides stop blocks which are integrally die-cast to provide relatively firm structure and more stable performance, and thereby allowing surface treatments of the stop blocks to be more diversified with lesser color differences. The rear fixing plate is installed inside the rear stop block, and likewise, the front position limiting rods are installed inside the front stop block; installation efficiency and stability of other parts of the indicator lock are improved by utilizing the mutual coordination between the front position limiting rods and the rear fixing plate, thereby making the indicator lock more rigid and durable during use.
2. According to the present utility model, the rear through member is provided inside the rear handle, instead of the common pin tumbler lock structure usually found in the existing indicator locks that require clockwise or anti-clockwise rotation of a knob to latch or unlatch the lock and hence resulting in the lack of emergency escape function which leads to reduced versatility of use of the indicator locks. The rear through member disposed inside the rear handle is formed by a single formation process by using existing cold rolled steel. A component formed by stamping and shaping a 1.5 mm thick cold rolled steel plate has stronger overall pressure resistance, making it more durable in use. Since the pressure spring is installed inside the rear through member, and the internal diameter of the rear through member corresponds to the external diameter of the pressing member, the pressing member is connected with the rear through member, and the pressing member is biased by the pressure spring in the rear through member. Rotate the pressing member disposed inside the rear through member until the mounting through hole formed on the upper peripheral portion of the pressing member aligns with the rear through rotary groove formed outside the rear through member, and then insert the guide pin through the rear through rotary groove into the mounting through hole, and also install the push button to an outer end of the pressing member. When the push button is pushed, the pressing member is driven to move downwardly to compress the pressure spring and at the same time rotates with respect to the rear through member towards one direction, so that the guiding pin connected to the pressing member also moves towards one direction in the rear through rotary groove which is opened along a circumferential direction of the rear through member. The guiding pin serves as a locking tongue such that when the push button is pushed, the guiding pin is moved to an unlocking position where the indicator lock is unlocked. When the pressing force on the push button is released so as to reset the pressing member by the resilience force of the pressure spring, the pressing member is driven to move upwardly and at the same time rotates towards an opposite direction with respect to the rear through member, so that the guiding pin also moves towards an opposite direction in the rear through rotary groove to reach a locking position where the indicator lock is locked. Accordingly, the pressing member, through the rear through rotary groove and the pressure spring, can form an up-down movable locking and unlocking structure with the rear through member where a downward movement of the pressing member enables an unlocking effect while an upward movement of the pressing member enables a locking effect, thereby preventing the use of door knob and rotation of the knob in the prior art to achieve locking and unlocking effect, and it is particularly beneficial to the disabled since unlocking effect can be achieved by simply pushing a button instead of rotating a knob to open the indicator lock as in the prior art. The indicator lock is made to have strong resilience in the use, the reset angle is precise, and the operation is smooth, and the service life is long.

### BRIEF DESCRIPTION OF THE DRAWINGS

FIG. 1 is a perspective view of an overall of a square shaped push-button type indicator lock with emergency escape function suitable for disabled people according to the present utility model;

FIG. 2 is a top plan view of the overall structure of the square shaped push-button type indicator lock with emergency escape function suitable for disabled people according to the present utility model;

FIG. 3 is a perspective view of the rear through member of the square shaped push-button type indicator lock with emergency escape function suitable for disabled people according to the present utility model;

FIG. 4 is a perspective view of the pressing member of the square shaped push-button type indicator lock with emergency escape function suitable for disabled people according to the present utility model;

FIG. 5 is a perspective view of a mechanism achieving a locked state of the square shaped push-button type indicator lock with emergency escape function suitable for disabled people according to the present utility model;

FIG. 6 is a perspective view of the mechanism achieving an unlocked state of the square shaped push-button type indicator lock with emergency escape function suitable for disabled people according to the present utility model;

FIG. 7 is a sectional view of the square shaped push-button type indicator lock with emergency escape function suitable for disabled people according to the present utility model.

In the figures: 1. Front handle; 2. Front stop block; 3. Rear handle; 4. Rear stop block; 5. Rear fixing plate; 6. Front position limiting rods; 7. Rear through member; 8. Rear through rotary groove; 9. Pressure spring; 10. Pressing member; 11. Mounting through hole; 12. Guide pin; 13. Push button.

### DETAILED DESCRIPTION OF THE INVENTION

Embodiments of the present utility model will be described in greater details with reference to the drawings and embodiments. The following embodiments are intended to illustrate the present utility model but are not intended to limit the scope of the present utility model.

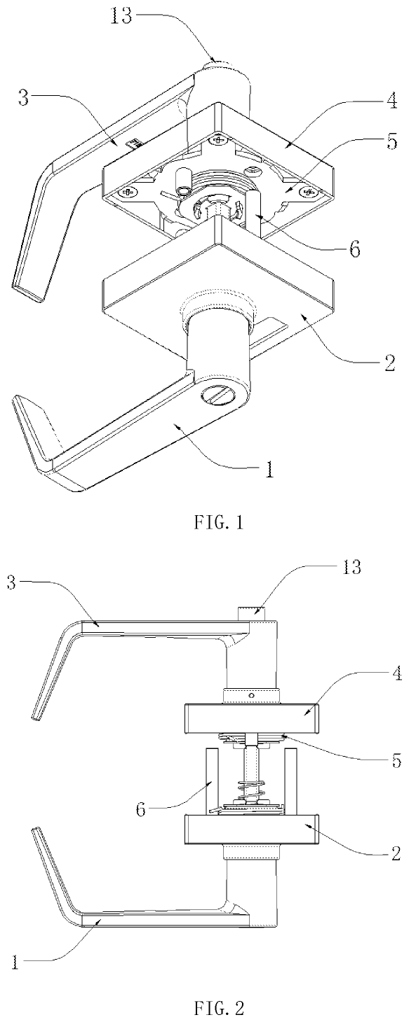

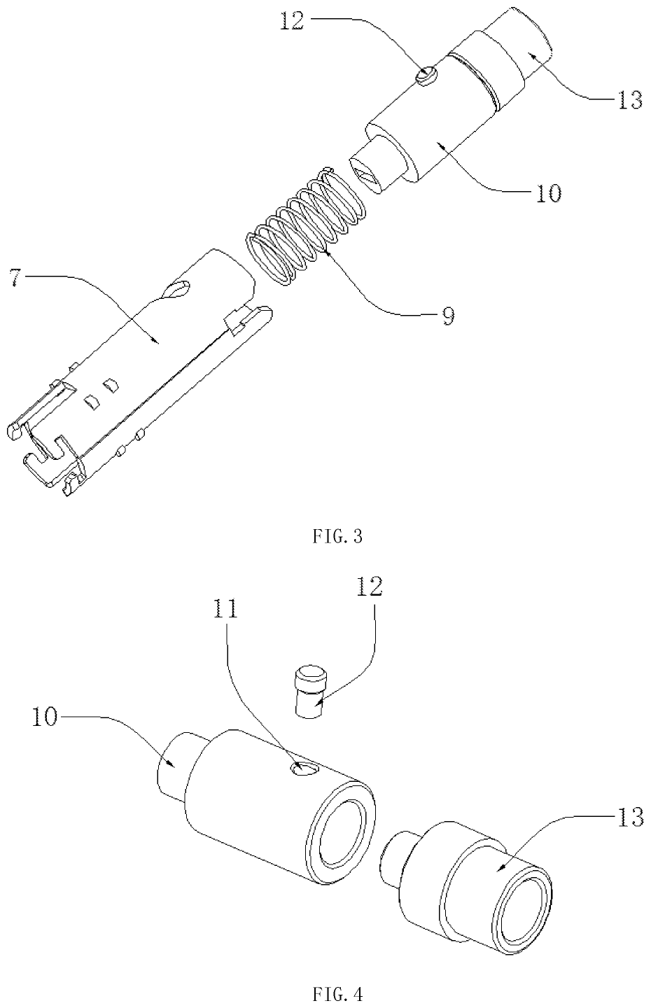

As shown in FIGS. 1 and 2, a square shaped push-button type indicator lock with emergency escape function suitable for disabled people is provided, comprising a front handle 1 and a rear through member 7. A front stop block 2 is installed at a front end of the front handle 1; a rear handle 3 is provided opposite to the front handle 1 at a position opposite to a front end of the front stop block 2, and a rear stop block 4 is installed at a front end of the rear handle 3 facing towards the front stop block 2; a rear fixing plate 5 is installed inside the rear stop block 4, and front position limiting rods 6 are installed inside the front stop block 2; the front stop block 2 has a square shape, and the front handle 1 is fixedly installed in a middle of an outer side of the front stop block 2; likewise, the rear stop block 4 has a square shape, and the rear handle 3 is installed in a middle of an outer side of the rear stop block 4; the front stop block 2 has same dimensions as the rear stop block 4. Compared with a circular assembled blocking cover, the present utility model provides stop blocks which are integrally die-cast to provide relatively firm structure and more stable performance, and thereby allowing surface treatments of the stop blocks to be more diversified with lesser color differences. The rear fixing plate 5 is installed inside the rear stop block 4, and likewise, the front position limiting rods 6 are installed inside the front stop block 2; installation efficiency and stability of other parts of the indicator lock are improved by utilizing the mutual coordination between the front position limiting rods 6 and the rear fixing plate 5, thereby making the indicator lock more rigid and durable during use.

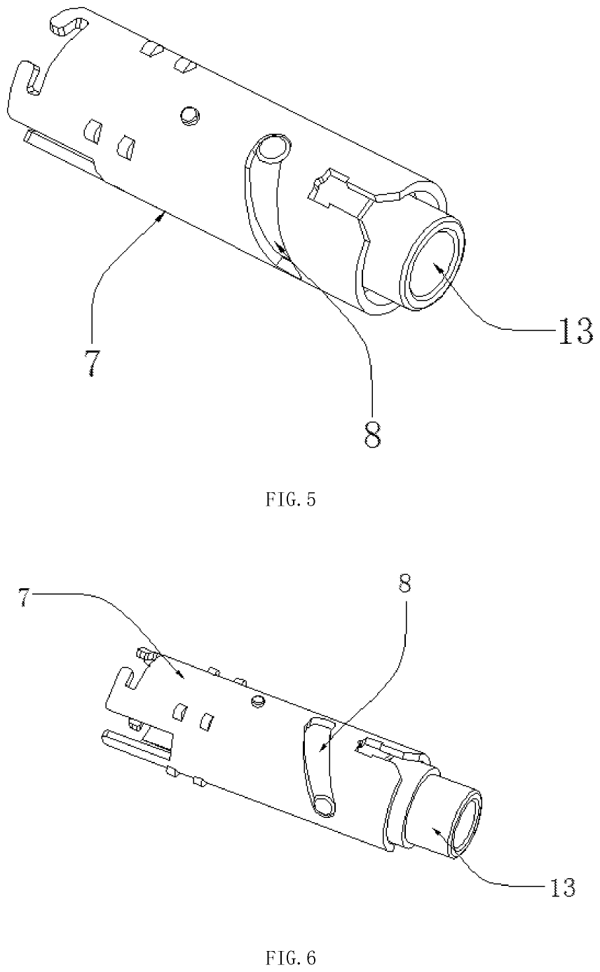

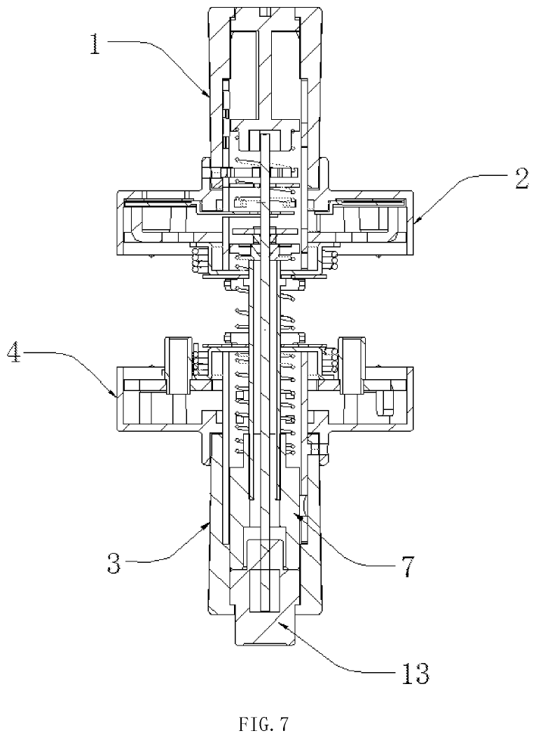

As shown in FIGS. 1 to 7, the rear through member 7 is installed inside the rear handle 3 proximal to the rear stop block 4, and a rear through rotary groove 8 is formed outside the rear through member 7; a pressure spring 9 is disposed inside the rear through member 7; a pressing member 10 is installed at a front end of the pressure spring 9; a mounting through hole 11 is formed on an upper peripheral portion of the pressing member 10, a guide pin 12 is installed in the mounting through hole 11; a push button 13 is disposed at an end of the pressing member 10 opposite to an end of the pressing member 10 installed with the pressure spring 9; an external diameter of the pressing member 10 corresponds to an internal diameter of the rear through member 7 so that an external surface of the pressing member 10 is positioned closely adjacent to an internal surface of the rear through member 7; the pressing member 10 is inserted into the rear through member 7, and the pressing member 10 is biased by the pressure spring 9 in the rear through member 7; an internal size of the rear through rotary groove 8 corresponds to an external size of the guide pin 12, and the pressing member 10 is rotatably connected with the rear through rotary groove 8 through the guide pin 12; therefore, as reflected by FIG. 5 and FIG. 6, by overcoming a biasing force of the pressure spring 9 or by allowing the biasing force of the pressure spring 9 to act on the pressing member 10, the guide pin 12 also moves in the rear through rotary groove 8 so that the pressing member 10 moves axially in the rear through member 7 and at the same time rotates in the rear through member 7; an internal diameter of the mounting through hole 11 corresponds to an external diameter of the guide pin 12, and the guide pin 12 is connected with the pressing member 10 through the mounting through hole 11. The rear through member 7 disposed inside the rear handle 3 is formed by a single formation process by using existing cold rolled steel. A component formed by stamping and shaping a 1.5 mm thick cold rolled steel plate has stronger overall pressure resistance, making it more durable in use. Since the pressure spring 9 is installed inside the rear through member 7, and the internal diameter of the rear through member 7 corresponds to the external diameter of the pressing member 10, the pressing member 10 is connected with the rear through member 7, and the pressing member 10 is biased by the pressure spring 9 in the rear through member 7. Rotate the pressing member 10 disposed inside the rear through member 7 until the mounting through hole 11 formed on the upper peripheral portion of the pressing member 10 aligns with the rear through rotary groove 8 formed outside the rear through member 7, and then insert the guide pin 12 through the rear through rotary groove 8 into the mounting through hole 11, and also install the push button 13 to an outer end of the pressing member 10. When the push button 13 is pushed, the pressing member 10 is driven to move downwardly to compress the pressure spring 9 and at the same time rotates with respect to the rear through member 7 towards one direction, so that the guiding pin 12 connected to the pressing member 10 also moves towards one direction in the rear through rotary groove 8 which is opened along a circumferential direction of the rear through member 7. The guiding pin 12 serves as a locking tongue such that when the push button 13 is pushed, the guiding pin 12 is moved to an unlocking position where the indicator lock is unlocked. When the pressing force on the push button 13 is released so as to reset the pressing member 10 by the resilience force of the pressure spring 9, the pressing member 10 is driven to move upwardly and at the same time rotates towards an opposite direction with respect to the rear through member 7, so that the guiding pin 12 also moves towards an opposite direction in the rear through rotary groove 8 to reach a locking position where the indicator lock is locked. Accordingly, the pressing member 10, through the rear through rotary groove 8 and the pressure spring 9, can form an up-down movable locking and unlocking structure with the rear through member 7 where a downward movement of the pressing member 10 enables an unlocking effect while an upward movement of the pressing member 10 enables a locking effect, thereby preventing the use of door knob and rotation of the knob in the prior art to achieve locking and unlocking effect, and it is particularly beneficial to the disabled since unlocking effect can be achieved by simply pushing a button instead of rotating a knob to open the indicator lock as in the prior art. Therefore, the indicator lock is made to have strong resilience in the use, the reset angle is precise, and the operation is smooth, and the service life is long.

To sum up, according to the square shaped push-button type indicator lock with emergency escape function suitable for disabled people, the front handle 1 is fixedly installed in the middle of the outer side of the square shaped front stop block 2; likewise, the rear handle 3 is installed in the middle of the outer side of the square shaped rear stop block 4; the front stop block 2 and the rear stop block 4 have the same dimensions. Compared with a circular assembled blocking cover, the present utility model provides stop blocks which are integrally die-cast to provide relatively firm structure and more stable performance, and thereby allowing surface treatments of the stop blocks to be more diversified with lesser color differences. The rear fixing plate 5 is installed inside the rear stop block 4, and likewise, the front position limiting rods 6 are installed inside the front stop block 2; installation efficiency and stability of other parts of the indicator lock are improved by utilizing the mutual coordination between the front position limiting rods 6 and the rear fixing plate 5, thereby making the indicator lock more rigid and durable during use. Further, the rear through member 7 disposed inside the rear handle 3 is formed by a single formation process by using existing cold rolled steel. A component formed by stamping and shaping a 1.5 mm thick cold rolled steel plate has stronger overall pressure resistance, making it more durable in use. Also, the push button 13 is formed by die casting with zinc alloy, so that it is more durable in use. Since the pressure spring 9 is installed inside the rear through member 7, and the internal diameter of the rear through member 7 corresponds to the external diameter of the pressing member 10, the pressing member 10 is connected with the rear through member 7, and the pressing member 10 is biased by the pressure spring 9 in the rear through member 7. Rotate the pressing member 10 disposed inside the rear through member 7 until the mounting through hole 11 formed on the upper peripheral portion of the pressing member 10 aligns with the rear through rotary groove 8 formed outside the rear through member 7, and then insert the guide pin 12 formed by turning a 304 stainless steel material through the rear through rotary groove 8 into the mounting through hole 11, and also install the push button 13 to an outer end of the pressing member 10. When the push button 13 is pushed, the pressing member 10 is driven to move downwardly to compress the pressure spring 9 and at the same time rotates with respect to the rear through member 7 towards one direction, so that the guiding pin 12 connected to the pressing member 10 also moves towards one direction in the rear through rotary groove 8 which is opened along a circumferential direction of the rear through member 7. The guiding pin 12 serves as a locking tongue such that when the push button 13 is pushed, the guiding pin 12 is moved to an unlocking position where the indicator lock is unlocked. When the pressing force on the push button 13 is released so as to reset the pressing member 10 by the resilience force of the pressure spring 9, the pressing member 10 is driven to move upwardly and at the same time rotates towards an opposite direction with respect to the rear through member 7, so that the guiding pin 12 also moves towards an opposite direction in the rear through rotary groove 8 to reach a locking position where the indicator lock is locked. Accordingly, the pressing member 10, through the rear through rotary groove 8 and the pressure spring 9, can form an up-down movable locking and unlocking structure with the rear through member 7 where a downward movement of the pressing member 10 enables an unlocking effect while an upward movement of the pressing member 10 enables a locking effect, thereby preventing the use of door knob and rotation of the knob in the prior art to achieve locking and unlocking effect, and it is particularly beneficial to the disabled since unlocking effect can be achieved by simply pushing a button instead of rotating a knob to open the indicator lock as in the prior art. The indicator lock is made to have strong resilience in use, the reset angle is precise, and the operation is smooth. It is worth mentioning that all parts that form the indicator lock have been hardened by high-temperature carburizing, so that the indicator lock is rigid in the use process and the service life is long.

The embodiments of the present utility model are presented for purposes of illustration and description, and are not intended to be exhaustive or to limit the present utility model to the form disclosed. Many modifications and variations will be apparent to persons of ordinary skill in the art. The embodiments are chosen and described in order to best explain the principles and the practical application of the present utility model, and to enable persons of ordinary skill in the art to understand the present utility model for designing various embodiments with various modifications suitable for particular uses.

What is claimed is:

1. A square shaped push-button type indicator lock with emergency escape function suitable for disabled people, comprising a front handle and a rear through member; wherein a front stop block is installed at a front end of the front handle; a rear handle is provided opposite to the front handle at a position opposite to a front end of the front stop block, and a rear stop block is installed at a front end of the rear handle facing towards the front stop block; a rear fixing plate is installed inside the rear stop block, and front position limiting rods are installed inside the front stop block; the rear through member is installed inside the rear handle proximal to the rear stop block, and a rear through rotary groove is formed outside the rear through member; a pressure spring is disposed inside the rear through member; a pressing member is installed at a front end of the pressure spring; a mounting through hole is formed on an upper peripheral portion of the pressing member, a guide pin is installed in the mounting through hole; a push button is disposed at an end of the pressing member opposite to an end of the pressing member installed with the pressure spring.

2. The square shaped push-button type indicator lock of claim 1, wherein an external diameter of the pressing member corresponds to an internal diameter of the rear through member so that an external surface of the pressing member is positioned adjacent to an internal surface of the rear through member.

3. The square shaped push-button type indicator lock of claim 1, wherein the pressing member is inserted into the rear through member, and the pressing member is biased by the pressure spring in the rear through member.

4. The square shaped push-button type indicator lock of claim 1, wherein an internal size of the rear through rotary groove corresponds to an external size of the guide pin, and the pressing member is rotatably connected with the rear through rotary groove through the guide pin.

5. The square shaped push-button type indicator lock of claim 1, wherein an internal diameter of the mounting through hole corresponds to an external diameter of the guide pin, and the guide pin is connected with the pressing member through the mounting through hole.
